(19) United States
(12) Patent Application Publication
(10) Pub. No.: US 2022/0127807 A1
(43) Pub. Date: Apr. 28, 2022

(54) Device for Melting Snow and Ice

(71) Applicant: Kerson Raymond, Teaneck, NJ (US)

(72) Inventor: Kerson Raymond, Teaneck, NJ (US)

(21) Appl. No.: 17/477,068

(22) Filed: Sep. 16, 2021

Related U.S. Application Data
(60) Provisional application No. 63/106,567, filed on Oct. 28, 2020.

(51) Int. Cl. E01H 5/10; F24H 3/04

(52) U.S. Cl. CPC E01H 5/106; A01G 20/47; F24H 3/0423

(57) ABSTRACT

A snow, ice and debris removal device is disclosed. The multipurpose device includes a handle, a cylindrically-shaped forced air blowing system and a plurality of controls. The cylindrical shaped forced air blowing system features a front opening for expelling cool or heated air, which is adjustable via a switch to suit the application for which the device is being used. The forced air blowing system comprises an internal induction heating/cooling coil that heats or cools the air expelled through the system. When the switch is set to hot air mode, the device expels a stream of heated air which the user can easily direct at snow and ice accumulations on, for example, a sidewalk, driveway, parked vehicle, etc. or to dry a surface. Alternatively, when the cool air mode is selected, the device expels a stream of cool air that the user can use to displace leaves and other debris.

### CROSS-REFERENCE TO RELATED APPLICATION

The present application claims priority to, and the benefit of, U.S. Provisional Application No. 63/106,567, which was filed on Oct. 28, 2020 and is incorporated herein by reference in its entirety.

### FIELD OF THE INVENTION

The present invention relates generally to the field of snow and ice removal devices. More specifically, the present invention relates to a device that is capable of not only melting snow and ice, but that can also serve as a leaf and other debris-blowing device. The device of the present invention features a forced-air blowing mechanism capable of being adjusted to emit either hot or cold air. The device eliminates the need to constantly bend over and risk injury and muscle aches/pains commonly associated with using shovels, rakes and other manual labor tools for removing snow, ice, leaves and other debris from a sidewalk, driveway and the like. Accordingly, the present specification makes specific reference thereto. However, it is to be appreciated that aspects of the present invention are also equally amenable to other like applications.

### BACKGROUND OF THE INVENTION

By the way of background, snowfall can create huge problems in outdoor areas such as sidewalks and driveways. Sidewalks are paths along the side of a road, generally set up on both sides of roads for people to walk. These sidewalks are often constructed of concrete or asphalt. A driveway is a type of private road in front of a house or other building for local access to one or more structures, and is owned and maintained by an individual or group. During the winter, the snowfall in many countries causes heavy ice and snow accumulation on these sidewalks and driveways which seriously affects people's ability to enter/exit driveways and utilize sidewalks. When a sidewalk or driveway is covered with snow and/or ice due to inclement weather, sidewalks and other paved surfaces can become extremely slippery, dangerous and difficult to navigate. Such conditions are extremely unfavorable for drivers, passengers and pedestrians to travel safely and as a result, traffic accidents and/or falls in winter often take place. Hence, accumulated snow and ice on sidewalks, driveways and other paved surfaces need to be removed for people's safety.

Currently, there are many methods for removing ice and snow from sidewalks and driveways such as snow blowers, snow melting devices, tools and more. Snow-removing devices such as shovels and the like are used to remove the snow accumulated over pathways, driveways, sidewalks and more. However, the shovel is used manually by a person to remove the accumulated snow and ice and it can be incredibly difficult to completely clear off sidewalks, pathways, driveways and the like. People may suffer from serious bodily injuries, aches and pains and may become physically exhausted from using a shovel to clear the accumulated snow. Additionally, the use of a manual shovel can be tiring, frustrating, time-consuming and ineffective for completely removing snow and ice. People with limited physical dexterity and suffering from various health conditions may be reluctant or incapable of shoveling snow. Such people may hire other people and pay them to get their sidewalks and driveways shoveled, which can be expensive over time, especially in snowy regions.

Also, in the case of continuous snowfall, use of conventional shovels is time-consuming and extremely difficult. Further, if sidewalks, driveways, and other surfaces are not fully cleared of snow and ice, such surfaces can become a tripping and falling hazard for individuals.

Further, in autumn, fallen leaves may accumulate over sidewalks, lawns and other outdoor areas. People may spend time raking and disposing of leaves after the fall season or before the snow accumulates, as fallen leaves can promote mold growth which may spread throughout lawns. Spending time raking and bagging leaves can be frustrating and time-consuming. For leaf removal, rakes and bags are required. People may have to buy multiple pieces of equipment for snow and leaf removal, which can become a big expense for many individuals.

Additionally, other solutions such as snow-melting are used to solve the problems of snow and ice accumulation. Millions of tons of salt are dumped on roadways every winter to melt the snow and ice and make the roads safer and passable. When the salt is added to ice and snow, the salt touches the thin layer of water which generally covers ice and snow, and the thin layer starts to dissolve, which subsequently lowers the freezing point, thereby melting the surrounding ice. Although the use of salt helps in melting ice and snow, there are various disadvantages to salt use such as rust or corrosion of automobiles, creation of potholes, etc. Additionally, use of salt on roads may cause corrosion to the rebar underneath the road surface, which leads to crumbling and cracking on the main surface, causing thousands of dollars of damage. Further, use of industrial salt or chemicals to lower the melting point of ice and snow greatly affects the earth's climate and the environment.

Therefore, there exists a long felt need in the art for a device for efficiently removing snow and ice from a sidewalk, driveway and the like, thereby saving the user considerable time and effort. There also exists a long felt need in the art for a device that is not only capable of removing snow and ice, but that can also function as a drying device for drying a surface and/or a blower device for removing leaves and other debris, and that does not require the user to bend over repeatedly and risk bodily injury or muscle pain. Additionally, there is a long felt need in the art for a portable device that melts the snow and ice from a sidewalk and/or driveway, but that does not cause damage thereto (e.g., cracks on the surface of the sidewalk and/or driveway). Finally, there is a long felt need in the art for a snow and ice removal device that is relatively inexpensive to manufacture and that is both safe and easy to use.

The subject matter disclosed and claimed herein, in one embodiment thereof, comprises a snow and ice removal device in the form of a multipurpose power tool. The device comprises a handle, a cylindrical-shaped forced-air blowing system and a plurality of controls. The cylindrical-shaped forced-air blowing system features a front opening for expelling cool or heated air, which is adjustable via a switch to suit the particular application for which the device is being used. The forced-air blowing system comprises an internal induction heating/cooling coil that heats or cools the air expelled through the system. When the switch is set to hot air mode, the device expels a stream of heated air which the user can easily direct at snow and ice accumulations on, for example, a sidewalk, driveway, parked vehicle, etc. Alternatively, when the cool air mode is selected, the device expels a stream of cool air that the user can use to displace leaves and other debris with relative ease or dry a surface.

In this manner, the snow and ice melting device of the present invention accomplishes all of the forgoing objectives, and provides an efficient way of both melting snow and ice, drying a surface and blowing away leaves and other debris. The device of the present invention is designed with a variety of operational and control features and can be easily handled and operated by a user with minimal manual effort.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an multipurpose power tool for clearing ice, snow, leaves and other debris from driveways, sidewalks, lawns, gardens and other outdoor areas, as well as a drying device for drying a surface. The power tool device comprises a handle, a cylindrical-shaped forced air blowing system and a switch. The cylindrical shaped forced-air blowing system features a gas or electrically powered motor, internal induction heating coil, a front opening for expelling cool or heated air, and controls for controlling the operation of the device. When the hot air mode is selected using the switch, the forced air blowing system expels relatively hot air which can be used to melting accumulated ice and snow on a surface by pointing the air discharge towards the same. Alternatively, when a cool air mode is selected using the switch, the forced air blowing system expels relatively cool air which can be used to displace leaves and other yard debris with ease.

In yet another embodiment of the present invention, a multifunctional device for melting snow and ice, as well as removing debris is disclosed. The multifunctional device is comprised of a generally cylindrical forced-air blowing system having a coil placed inside the structure of the forced-air blowing system, and having an air opening at both the ends of the cylindrical structure. The first air opening is used to intake air from the surroundings, and the second air opening expels out the air from the air blowing system after it has passed over the coil, which can be selectively heated or cooled by the user to selectively heat or chill the air being discharged from the device. The multifunctional device further comprises a handle positioned at the top surface of the forced-air blowing system to enable a user to hold and carry the multifunctional device while melting snow or ice, or while displacing fallen leaves and other debris from sidewalks, driveways and more. A mode selection switch is provided on the outer surface of the multifunctional device, preferably on the handle to enable a user to select a hot air or cool air mode, for expelling hot air or cool air through the air blowing system.

In a further embodiment of the present invention, a method of using a multifunctional device for melting snow and ice is disclosed. The method begins with the user initially selecting a hot air mode by using a switch on the multifunctional device. Next, the multifunctional device is pointed or aimed towards the snow and ice accumulated on a sidewalk, driveway or other surface, such that the device blows a stream of heated air onto the same. More specifically, when the device is turned “ON” an electrical current passes through a coil within the device and causes the same to become hot, which in turn will heat the flow of air passing through the device in close proximity to the heated coil. The forced air blowing mechanism of the multifunctional device the expels the hot air to melt the targeted snow and/or ice accumulated on the sidewalk, driveway or other surface.

In a further embodiment of the present invention, a method of using a multifunctional device for displacing leaves and other debris from lawns, gardens, yards, sidewalks, driveways and more is disclosed. The method begins with the user initially selecting a cool air mode by using a switch on the multifunctional device. Next, the device is pointed towards the fallen leaves or other accumulated debris, such that the stream of air created by the device displaces the same in a desired direction. Based on the cool air mode selection, the internal coil cools the air or, at least doesn't heat the same. The expelled cool air blows away the fallen leaves and other debris and clears the sidewalks, driveways and other similar surfaces.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the multipurpose device of the present invention in accordance with the disclosed architecture;

FIG. 2 illustrates a partial perspective view of one potential embodiment of the front portion of the multipurpose device of the present invention in accordance with the disclosed architecture;

FIG. 3 illustrates a perspective view of one potential embodiment of the temperature adjustment control of the multipurpose device of the present invention in accordance with the disclosed architecture;

FIG. 4 illustrates a perspective view of one potential embodiment of the internal coil of the multipurpose device of the present invention in accordance with the disclosed architecture;

FIG. 5 illustrates a perspective view of one potential embodiment of the multipurpose device of the present invention in accordance with the disclosed architecture, wherein the device is discharging a stream of cooled air;

FIG. 6 illustrates a perspective view of one potential embodiment of the multipurpose device of the present invention in accordance with the disclosed architecture, wherein the device is discharging a stream of air to discharge fallen leaves from a surface; and

FIG. 7 illustrates a perspective view of one potential embodiment of the multipurpose device of the present invention in accordance with the disclosed architecture, wherein the device is discharging a stream of heated air to melt and accumulation of snow and ice from a paved surface.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a handheld and easily portable device for melting accumulated snow and ice on a sidewalk, driveway or other surface (e.g., the windshield of a vehicle), thereby saving the user considerable time and effort. There also exists a long felt need in the art for a device that is not only capable of removing snow and ice, but that can also function as a drying device for drying a surface and a blower device for removing leaves and other debris, and that does not require the user to bend over repeatedly and risk bodily injury or muscle pain. Additionally, there is a long felt need in the art for a portable device that melts the snow and ice from a sidewalk and/or driveway, but that does not cause damage thereto (e.g., cracks on the surface of the sidewalk and/or driveway). Finally, there is a long felt need in the art for a snow and ice removal device that is relatively inexpensive to manufacture and that is both safe and easy to use.

The present invention, in one exemplary embodiment, is a novel multipurpose power tool for clearing snow, ice, leaves and other debris from driveways, sidewalks, lawns, gardens, and other outdoor areas. The power tool comprises a handle, a generally cylindrical shaped forced-air blowing system and a control panel. The generally cylindrical shaped forced air blowing system features a front opening for expelling cooled or heated air, wherein the temperature of the air being discharged is adjustable via the control panel. The forced air blowing system further comprises a gas or electrically powered motor and an internal induction heating/cooling coil that heats or cools the air expelled through the system. For example, when a user desires to melt an accumulation of snow or ice, he or she would select a hot air mode and direct the stream of heated air at the accumulation. Alternatively, when a user desires to clear an area of leaves and other debris, the removal of which does not require a stream of hot air, the user would simply select the cool air mode on the control panel and direct the flow of cool air generated by the device at the leaves and other yard debris.

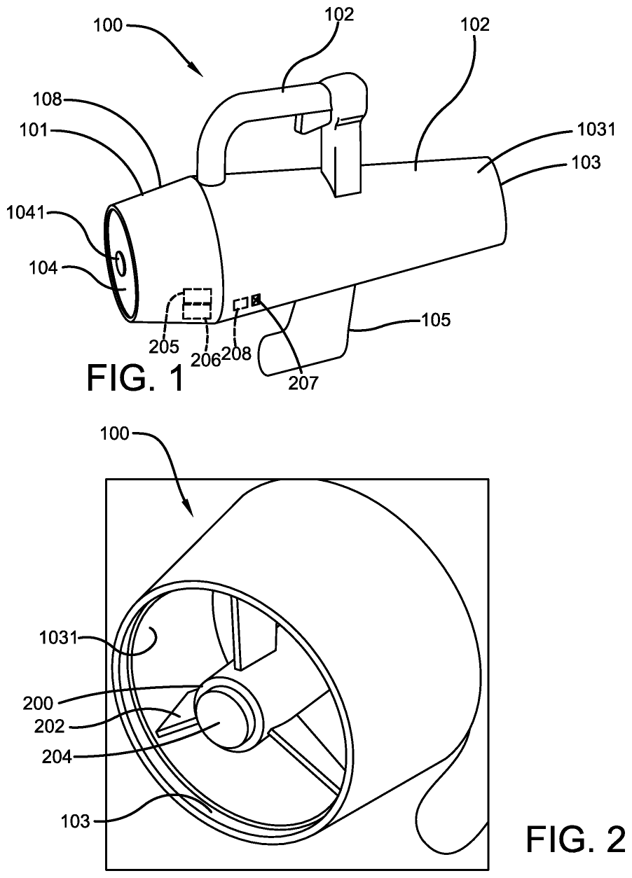

Referring initially to the drawings, FIG. 1 illustrates a perspective view of one potential embodiment of the multipurpose device or power tool 100 of the present invention in accordance with the disclosed architecture. Generally stated, the multipurpose device 100 comprises a forced-air blowing system 101, a handle 102, a front portion 103, a back portion 104 and a mounting means 105.

The forced air blowing system 101 of the multipurpose device 100 is preferably a generally cylindrically shaped structure or housing 108 that houses a blower assembly 200, a motor 205, a battery 206, a processor/wireless communication module 208 and a heating/cooling coil 400 that is used to heat or cool a stream of air that passes through or past the coil 400. The front portion 103 of the forced air blowing system 101 comprises an air release opening 1031 for expelling the heated or cooled air from the system 101. Likewise, the back portion 104 of the forced-air blowing system 101 comprises an air intake opening 1041 to intake ambient air from the surroundings and pass the same over or through the coil 400 to increase or decrease the temperature of the incoming air as desired by the user prior to discharging the same through the front air release opening 1031. The wireless communication module 208 is capable of linking the device 100 with a remote electronic device (not shown), such as a smart phone, to enable the user to remotely control the settings or operation of the device 100.

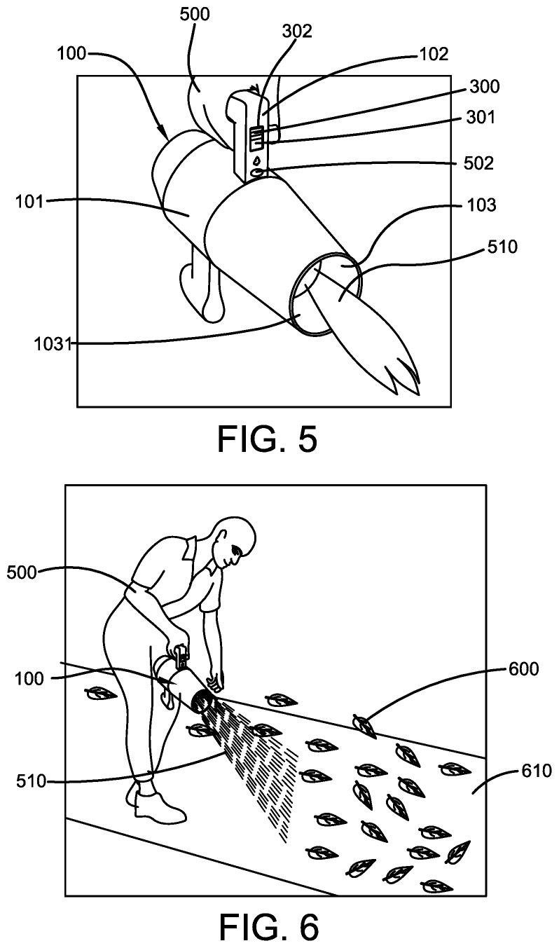

The handle 102 of the multipurpose device 100 enables a user to hold or carry the device 100 while using the device 100, or to transport the device 100 from one place to another. The handle 102 can be a simple and generally C-shaped handle or any other shaped handle that is ergonomically easy to grip and hold in the user's hand. Additionally, as best shown in FIGS. 1 and 5, a mounting means 105 enables the device 100 to stand firmly on any surface when not in use. The cylindrical shaped air blowing system 101 and handle 102 can be constructed using a durable and weather resistant material such as, but not limited to, a plastic, metal, metal alloy, suitable polymers or a combination thereof. Further, different components of the device 100 may be constructed from different materials separately and can be assembled as single unit.

FIG. 2 illustrates a partial perspective view of one potential embodiment of the front portion of the multipurpose device 100 of the present invention in accordance with the disclosed architecture. As shown, the front portion 103 of the multipurpose device 100 comprises a front opening 1031, which is preferably circular or oval in shape though the same is not require to be. The blower assembly 200 is positioned within the housing 108, but adjacent to the opening 1031. The blower assembly comprises a plurality of blades 202 (preferably three, but not so limited thereby) mounted on a central shaft 204 which revolves and is mechanically powered by the motor 205. More specifically, during operation of the multipurpose device 100 the motor 205 powers the central shaft 204 and the plurality of blades 202 causing them to rotate in a clockwise or counterclockwise direction. The blades 202 are pitched or angled so that as they rotate, ambient air in drawn into the housing 108 via the air intake opening 1041 in the back portion 104 of the device 100 and forced forward past the coil 400 where it is heated or cooled before being discharged through the front opening 1031 in the front portion 103. Stated differently, the temperature of the air as it is discharged at the front opening 1031 is different than the temperature of the air at the air intake opening 1041.

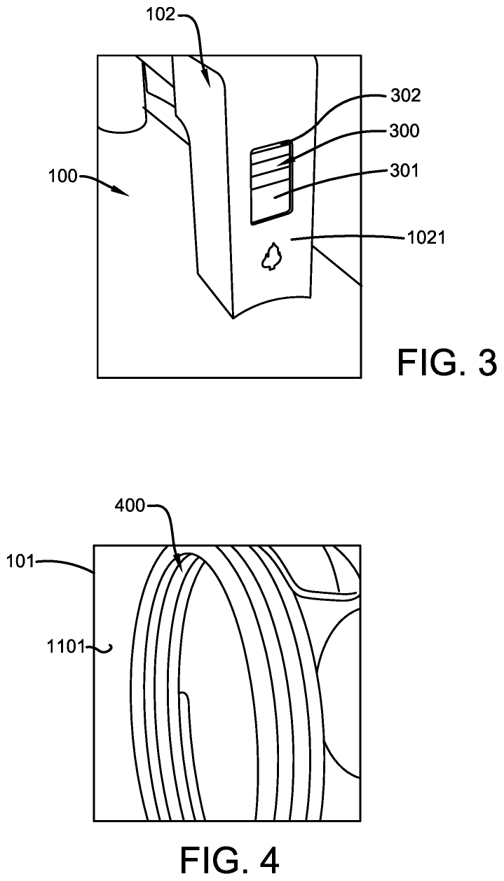

FIG. 3 illustrates a perspective view of one potential embodiment of the temperature adjustment control 300 of the multipurpose device 100 of the present invention in accordance with the disclosed architecture. As shown, a control panel or mode selection switch 300 is preferably positioned on the front surface 1021 of the handle 102 of the device 100. In its simplest form, the mode selection switch 300 can be set to a cool air mode 301 or a hot air mode 302 using a sliding switch mechanism. However, any other type of knob, control or switch can also be used by the user 500 to control the operation of the device 100 including, without limitation, the power supply, mode of operation, temperature, intensity/velocity of the blown air being discharged from the device 100, etc. For example, the switch 300 can also be a push button, a touch panel or switching mechanism enabling a user to select a mode of air to be released out of the device 100 for different applications. Additionally, the position of the switch 300 is not limited, and can be positioned at any other surface of the handle 102 or the device 100, while providing convenience for users in accessing the switch 300.

FIG. 4 illustrates a perspective view of one potential embodiment of the internal coil 400 of the multipurpose device 100 of the present invention in accordance with the disclosed architecture. More specifically, the coil 400 is preferably comprised of copper or other suitable temperature-conducive metal that is capable of being heated or cooled with, for example, an electric current from a power source such as an extension cord plugged into a power connection port 207 on the housing, an internal battery, a generator or the like. The coil 400 works in coordination with the hot or cool air mode selected by the user using the control panel switch 300. More specifically, when the device 100 is turned “ON” and the hot air mode is selected by the user 500, an electrical current passes through the coil 400 within the device 100 and causes the same to become hot, which in turn will heat the flow of air passing through the housing 108 before it is discharged through the front opening 1031 in the front portion 103 in the direction of the accumulation of the ice or snow to be melted.

Similarly, when the device 100 is turned “ON” and the cool air mode is selected by the user 500, an electrical current passes through the coil 400 (or does not pass through) within the device 100 and causes the same to become cool (or at least not heated), which in turn will cool the flow of air passing through the housing 108 before it is discharged through the front opening 1031 in the front portion 103 in the direction of the fallen leaves or other debris to be displaced.

FIG. 5 illustrates a perspective view of one potential embodiment of the multipurpose device 100 of the present invention in accordance with the disclosed architecture, wherein the device 100 is discharging a stream of cooled air. As shown, a user 500 holds the handle 102 of the device 100, and selects cool air mode 301 by sliding the switch 300 and blocking the hot air mode 302. Then, the user 500 uses the power button 502 to turn ON the device 100, which may be gas or electric powered. If electrically powered, the device 100 may be powered by a traditional electric source via an extension cord (not shown) that is plugged into both a wall outlet and the power connection 207 on the housing, or the device 100 may be powered by a rechargeable battery.

Once the multipurpose device 100 is turned ON and in the cool air mode 301 selection, the internal coil 400 starts cooling the air inside the cylindrical shaped air blowing system 101, and the blower assembly 200 expels the cooled air 510 through the air release opening 1031 on the front portion 103 of the multipurpose device 100. The discharged stream of air 510 can then be directed towards the fallen leaves on the ground, pathways or the like to direct it for raking or disposal. Alternatively, in a hot air mode 302, the air release opening 1031 may be directed towards accumulated snow and ice to raise the temperature of the same and melt it from a sidewalk, driveway or other surface.

FIG. 6 illustrates a perspective view of one potential embodiment of the multipurpose device 100 of the present invention in accordance with the disclosed architecture, wherein the device 100 is discharging a cooled stream of air 510 to discharge fallen leaves from a surface. As shown, the user 500 is holding the multipurpose device 100 and using the same in cool air mode 301. While in operation, the device 100 expels cool air 510 for raking and displacing leaves 600 over the pathways, sidewalks or other similar areas 610.

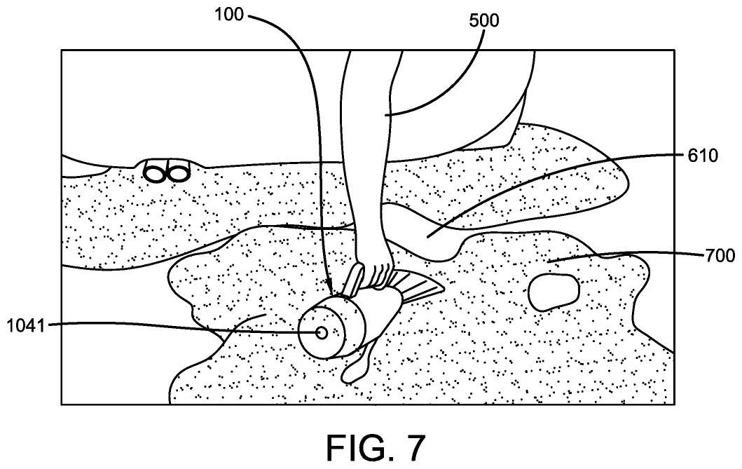

FIG. 7 illustrates a perspective view of one potential embodiment of the multipurpose device 100 of the present invention in accordance with the disclosed architecture, wherein the device 100 is discharging a stream of heated air to melt an accumulation of snow and ice from a paved surface. As shown, a user 500 selects a hot air mode of the multipurpose device 100 to expel a stream of hot air 700 through the forced-air blowing system 101. More specifically, the internal coil 400 heats the air sucked in from the surroundings by the air intake opening 1041, and expels the stream of hot air 700 through the air release opening 1031 with the help of the blower assembly 200. The user 500 can point the forced hot air stream 700 at a desired location for melting snow/ice 710 over a sidewalk 610 or other similar surface. The hot air 700 raises the temperature of the snow/ice 710, thereby causing the same to melt. Further, the hot air 700 causes the moisture to evaporate and leave the surface 610 both clean and dry. In this manner, the multipurpose device 100 of the present invention offers users 500 a convenient and stress-free method of melting and removing snow and ice 710 from a surface with minimal manual labor.

Certain terms are used throughout the following description and claim to refer to a particular feature or component. As one skilled in the art will appreciate, different persons may refer to the same feature or component by different names. This document does not intend to distinguish between components or features that differ in name but not structure or function. As used herein “multipurpose tool”, “multipurpose power tool” and “device for melting snow and ice” are interchangeable and refer to the multipurpose device 100 of the present invention.

Notwithstanding the forgoing, the multipurpose device 100 of the present invention and its various structural components can be of any suitable size, shape, color, style and configuration as is known in the art without affecting the overall concept of the invention, provided that it accomplishes the above-stated objectives. One of ordinary skill in the art will appreciate that the shape and size of the multipurpose device 100 and its various components, as show in the FIGS. are for illustrative purposes only, and that many other shapes and sizes of the multipurpose device 100 and its components are well within the scope of the present disclosure. Although dimensions of the multipurpose device 100 and its components i.e., length, width, and height are important design parameters for good performance, the multipurpose device 100 of the present invention and its components may be of any shape, size, color and style that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device for melting an accumulation of snow or ice from a surface, the device comprising:
a housing;
a forced air blowing system;
an air inlet;
an air outlet; and
a coil.

2. The device for melting an accumulation of snow or ice from a surface as recited in claim 1 further comprising a motor.

3. The device for melting an accumulation of snow or ice from a surface as recited in claim 2 further comprising a battery.

4. The device for melting an accumulation of snow or ice from a surface as recited in claim 2 further comprising a power connection.

5. The device for melting an accumulation of snow or ice from a surface as recited in claim 2 further comprising a power source.

6. The device for melting an accumulation of snow or ice from a surface as recited in claim 5, wherein the power source is electrically powered.

7. The device for melting an accumulation of snow or ice from a surface as recited in claim 5, wherein the power source is gasoline powered.

8. The device for melting an accumulation of snow or ice from a surface as recited in claim 5, wherein the coil is in electrical communication with the power source.

9. The device for melting an accumulation of snow or ice from a surface as recited in claim 8, wherein the coil is controlled by a control switch.

10. The device for melting an accumulation of snow or ice from a surface as recited in claim 9, wherein the control switch is repositionable between a hot air mode and a cool air mode.

11. The device for melting an accumulation of snow or ice from a surface as recited in claim 10, wherein the coil heats a flow of air passing through the housing and out of the air outlet when the control switch is in the hot air mode.

12. The device for melting an accumulation of snow or ice from a surface as recited in claim 10, wherein the coil cools a flow of air passing through the housing and out of the air outlet when the control switch is in the cool air mode.

13. A multipurpose device for generating a stream of forced air at a user selectable temperature, the multipurpose device comprising:
a housing having an air inlet positioned at a first end of the housing and an air outlet positioned at a second end of the housing;
a coil;
a power source;
a control panel; and
a blower assembly.

14. The multipurpose device for generating a stream of forced air at a user selectable temperature as recited in claim 10, wherein the coil and the blower assembly are positioned in an interior of housing and between the air inlet and the air outlet.

15. The multipurpose device for generating a stream of forced air at a user selectable temperature as recited in claim 13, wherein the coil is in electrical communication with the power source and the control panel.

16. The multipurpose device for generating a stream of forced air at a user selectable temperature as recited in claim 13, wherein the control panel comprises a hot air mode and a cool air mode.

17. The multipurpose device for generating a stream of forced air at a user selectable temperature as recited in claim 13, wherein the blower assembly comprises a plurality of blades attached to a rotatable shaft.

18. The multipurpose device for generating a stream of forced air at a user selectable temperature as recited in claim 17, wherein each of the plurality of blades are angled at a pitch.

19. The multipurpose device for generating a stream of forced air at a user selectable temperature as recited in claim 18, wherein the pitch of the plurality of blades draws a flow of ambient air into the housing through the air inlet, past the coil and expels the flow through the air outlet when the rotatable shaft is rotated.

20. A multipurpose device for generating a stream of forced air at a user selectable temperature, the multipurpose device comprising:
a housing having an air inlet positioned at a first end of the housing and an air outlet positioned at a second end of the housing;
a coil for altering a temperature of the stream of forced air after said stream enters the housing at the air inlet and before the stream exits the housing at the air outlet;
a power source;
a control panel for controlling a temperature of the coil; and
a blower assembly.
